(19) United States
(12) Patent Application Publication
(10) Pub. No.: US 2015/0052969 A1
(43) Pub. Date: Feb. 26, 2015

(54) Calibrating a Device

(71) Applicant: Advanced Sensor Design Technologies, LLC, Houston, TX (US)

(72) Inventor: Keith Jenkins, Houston, TX (US)

(21) Appl. No.: 14/465,076

(22) Filed: Aug. 21, 2014

Related U.S. Application Data
(60) Provisional application No. 61/868,293, filed on Aug. 21, 2013.

(51) Int. Cl. G01L 27/00

(52) U.S. Cl. CPC G01L 27/002
USPC 73/1.59

(57) ABSTRACT

The present disclosure involves methods, systems and computer program products for calibrating a measuring device to ensure that its overall accuracy is improved. The method includes generating a profile of a first and second device. The profiles may be generated using one or more profiling scenarios. The method includes comparing a profile of the second device against a profile of the first device, automatically adjusting the profile of the second device such that it substantially matches the profile of the first device, and transferring the adjusted profile to the second device. The transferring of the adjusted profile to the second device causes the second device to provide substantially the same output as the first device in response to the same input parameter.

### CROSS-REFERENCE TO RELATED APPLICATION

This application claims priority to U.S. Provisional Application No. 61/868,293, filed Aug. 21, 2013.

### BACKGROUND AND FIELD OF INVENTION

The present disclosure relates to the calibration of a measuring device. In particular, the present disclosure relates to the calibration of a sensor.

Many measuring devices are configured to detect changes in a quantity and provide a corresponding output. For example, a sensor can be used to detect changes in pressure, temperature, flow measurement, etc. and then provide a corresponding output signal. The signal can be read by an observer or a computer or other electronic instrument. Sensors are used in various industries, for example, medical devices, automobiles, oil and gas industry, aerospace, etc. to mention a few.

In certain applications, especially mission critical applications, it may be important to capture even minute changes or fluctuations in the measured quantity. It is also important that the readings are highly accurate. However, sensors can be expensive. Furthermore, there can be a direct correlation between the accuracy of the sensor and its cost.

### SUMMARY

According to a first embodiment, there is provided a computer-implemented method for calibrating a second device against a first device. The first device can be a substantially accurate standard device. The second device can be relatively inaccurate in comparison to the first device. The first and second devices are configured to measure an input parameter and provide an output parameter. The method includes generating a profile of the first device and generating a profile of the second device. The profiles may be computer-generated.

The profiles may be generated using one or more profiling scenarios. The method includes comparing a profile of the second device against a profile of the first device, automatically adjusting the profile of the second device such that it substantially matches the profile of the first device, and transferring the adjusted profile to the second device. The transferring of the adjusted profile to the second device causes the second device to provide substantially the same output as the first device in response to the same input parameter. The first and the second devices can be pressure transducers. The first device and the second device can be configured to measure a parameter, such as, fluid pressure.

According to a second embodiment, there is provided a computer program product for calibrating a second device against a first device including one or more non-transitory storage mediums, program instructions stored on the one or more non-transitory storage mediums, wherein the program instructions are able to be executed by one or more processors. The program instructions can be used for generating a profile of the first device and generating a profile of the second device. The profiles may be generated using one or more profiling scenarios. The program instructions include comparing a profile of the second device against a profile of the first device, automatically adjusting the profile of the second device such that it substantially matches the profile of the first device, and transferring the adjusted profile to the second device. The transferring of the adjusted profile to the second device causes the second device to provide substantially the same output as the first device in response to the same input parameter. The first and the second devices can be pressure transducers. The first device and the second device can be configured to measure a parameter, such as, fluid pressure.

According to a third embodiment, there is provided a system. The system can be a data processing system (‘computer’). The system comprises one or more processors, one or more non-transitory storage mediums and a computer memory operatively coupled to the processor. The computer memory of one or more of the systems has disposed within it computer program instructions for execution on the processor to implement one or more of the method embodiments described above. The computer program instruction may be stored on the one or more non-transitory storage mediums.

The foregoing and other objects, features and advantages of the disclosure will be apparent from the following more particular descriptions of exemplary embodiments of the invention as illustrated in the accompanying drawings.

### BRIEF DESCRIPTION OF THE FIGURE

The features and advantages of certain embodiments will be more readily appreciated when considered in conjunction with the accompanying figures wherein like reference numbers generally represent like parts of exemplary embodiments of the invention. The figures are not to be construed as limiting any of the preferred embodiments.

FIG. 1 represents a schematic view according to one embodiment of the invention.

FIG. 2 represents a flow diagram according to another embodiment of the invention.

### DETAILED DESCRIPTION

As used herein, the words “comprise,” “have,” “include,” and all grammatical variations thereof are each intended to have an open, non-limiting meaning that does not exclude additional devices or steps. As used herein, a “fluid” is a substance having a continuous phase that tends to flow and to conform to the outline of its container when the substance is tested at a temperature of 71° F. (22° C.) and a pressure of one atmosphere “atm” (0.1 megapascals “MPa”). A fluid can be a liquid or gas.

There are certain features which have to be considered when selecting a measuring device. They include its accuracy and cost. In order to ensure that a quantity is measured accurately, the measuring device should be accurately calibrated. Calibration involves the process of setting the measuring device into its optimal state. Calibration can ensure that the measuring device provides accurate indication or output signal. Errors can also be detected during the calibration process. While calibration is performed against a standard instrument having a high degree of accuracy, the calibrated device may not be as accurate as the standard instrument. This can be detrimental in applications that require a high degree of accuracy. It is, therefore, important to calibrate a measuring device such that its output is substantially similar to that provided by a standard instrument. The present disclosure involves methods, systems and computer program products for accurately calibrating a device. The present disclosure also involves recalibration of a previously calibrated device in order to ensure that its overall accuracy is improved.

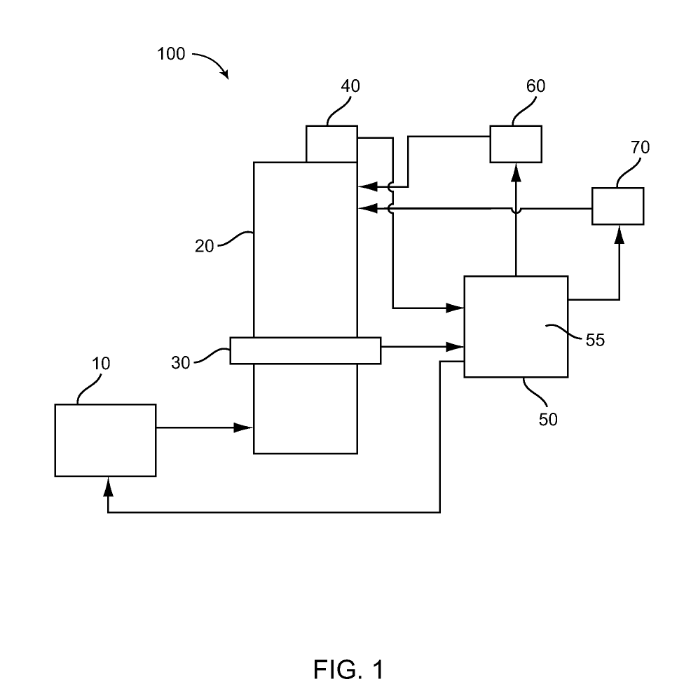

Referring to FIG. 1, a system for calibrating a device 100 includes a calibrator 50. The calibrator 50 can be configured to calibrate a device. As used herein, the term “device” is used to mean any instrument, equipment or apparatus that is configured to measure a parameter. As used herein, the term “parameter” is used to mean a quantity, material or object. The parameter can include pressure, strain, temperature, velocity, acceleration, etc. The calibrator 50 can be a data processing system or a computer.

The calibrator 50 can be operatively coupled to a first device 30 and a second device 40. The first device 30 and the second device 40 can be selected based on their ability to measure a desired parameter. In one embodiment, the first device 30 and the second device 40 can be a pressure transducer or sensor. Pressure transducers are known in the art and are not described herein. The first device 30 and the second device 40 can be configured to convert the measured parameter, for example, the pressure measurements, into digital/analog/wireless signals. The first device 30 can be a substantially precisely and accurately pre-calibrated device. The first device 30 can be a standard instrument that has a relatively high degree of accuracy. The second device 40 is not pre-calibrated. Alternately, the second device 40 may also be pre-calibrated. However, even if it is pre-calibrated, the second device 40 does not possess the accuracy of the first device 30. The second device 40 may be relatively inexpensive in comparison to the first device 30.

The first device 30 and the second device 40 can be connected to container 20. It should be noted that container 20 refers to any apparatus, such as a tank, that is capable of holding a material (oil, water, air or other fluid). The container 20 can include a fluid. The first device 30 and the second device 40 can be used to measure a parameter, for example, pressure exerted by the fluid in the container 20. The first device 30 is configured to substantially accurately measure the fluid pressure in container 20. However, the fluid pressure measurements made by the second device 40 may be relatively inaccurate in comparison to those made by the first device 30. The first device 30 and the second device 40 are configured to transmit the measured output as digital, analog or wireless signals to the calibrator 50.

The calibrator 50 can be configured to control the operation of the pressure source 10. The pressure source 10 can be, for example, a hydraulic pump. The pressure source 10 can be connected to the container 20. The pump 10 can put the fluid in the container 20 in motion by adding kinetic energy to it. This energy may be observed as pressure. For example, the pressure source 10 can be controlled to ramp up or ramp down the fluid pressure in the container 20.

The first device 30 and the second device 40 can be configured to measure pressure changes in response to one or more input variables (such as, speed, temperature, acceleration, etc.). A temperature sensor 60 and/or an accelerator 70 can be operatively connected to the calibrator 50 and the container 20. The calibrator 50 can control and monitor the readings from the temperature sensor 60 and the accelerator 70. The calibrator 50 can be configured to create a temperature profile for the first device 40 and the second device 30. The one or more embodiments are configured to ensure that the second device 30 is capable of accurately measuring pressure in even the harshest of conditions. Similarly, the calibrator 50 is capable of measuring the pressure changes in response to varying vibrations. The performance of a pressure transducer can be affected by changes in static pressure. In order to reduce these effects, the one or more embodiments of the invention can be calibrated at line pressure.

The calibrator 50 can be configured to automatically generate a profile of the first device 30 and a profile of the second device 40. The profile can be, for example, in a table form where one or more input parameters can be mapped to the corresponding output produced. The input parameter can be, for example, fluid pressure under a plurality of temperature conditions. A profile can be a very accurate description of a device. The profile can be generated in a table format. The calibrator 50 can be configured to generate the profiles according to one or more profiling scenario(s). For example, the first profiling scenario may involve the measurement of the parameter by the first device 30 and the second device 40 at a one or more predetermined calibration points. Ideally, the profiling is carried out for a large number of calibration points. For instance, the first device 30 and the second device 40 may be profiled by measuring the fluid pressure in the container 20 at 1000 calibration points. In a second profiling scenario, the parameter can be measured at one or more random calibration points. In a third profiling scenario, the parameter can be measured at one or more predetermined intervals. For instance, the first device 30 or the second device 40 may be profiled by measuring the fluid pressure in the container 20 at one or more intervals of 100 psig. The various profiling scenarios may also be combined. The profiling scenarios mentioned above are merely for illustrative purposes only and are not intended to be limiting in any manner. The profiling scenarios may be predetermined or they may be custom generated by the calibrator 50 during the calibration process based on the device to be calibrated, operational conditions, environmental conditions, etc. The profiling of the first device 30 and the second device 40 may occur simultaneously or they may occur separately.

The calibrator 50 can receive and store the output signals received from the first device 30 and the second device 40. The calibrator 50 can be configured to analyze the output signals received from first device 30 and to create a first profile P1. The first profile P1 can be considered an “optimal” profile. The calibrator 50 can be further configured to analyze the output signals received from the second device 40 and to create a second profile P2. The second profile may be a “sub-optimal” or lower-accuracy profile. The calibrator 50 can be configured to compare the first profile P1 and the second profile P2. If the comparison detects a difference between the two profiles, profile P2 is adjusted such that it substantially matches profile P1. The calibrator 50 can transmit the adjusted profile P2 to the second device 40 such that the second device 40 can be calibrated against the first device 30. The transmission of the adjusted profile P2 to second device 40 can cause the second device 40 to provide substantially the same output as that provided by the first device 30 in response to the same input parameter. The process (of profiling, adjusting and transmission of the adjusted profile) can be repeated until both profiles, P1 and P2, are determined to be substantially identical. Upon this determination, the calibration of the second device 40 may be completed.

In this manner, the profile of the second device 40 can be fine tuned to match the profile of the first device 30. The second device 40 can be calibrated such that it substantially takes on the “profile” or personality of the accurately calibrated first device 30. In effect, the accuracy of the second device 40 can be substantially improved such that it can accurately measure a parameter similar to the first device 30. Thus, the calibrator 50 can calibrate or recalibrate the second device 40 such that it is capable of functioning like the first device 40 (that is, it is capable of making highly accurate measurements). In one embodiment, the calibrator 50 can be provided by Advanced Sensor Design Technologies LLC. In one embodiment, the calibrator 50 can be portable.

It is understood that the calibrator can be configured to transfer the profile of the first device to a third, fourth, fifth etc. device. In this manner, one or more relatively inexpensive devices can be accurately calibrated. Thus, the inexpensive devices can take on the profile of a more expensive device. In one or more embodiments, the predictability and accuracy of any measurement made by an inexpensive device can be improved. Since the inexpensive devices can substantially accurately measure pressure, the inexpensive devices can be very cost-effective substitutes for the more expensive device. The accurately calibrated inexpensive devices can be used in mission critical operations and in various industries, such as, automotive, medical devices, oilfield tools and consumer goods. The one or more embodiments can make it affordable to utilize a plurality of inexpensive sensors/measuring devices as part of a system.

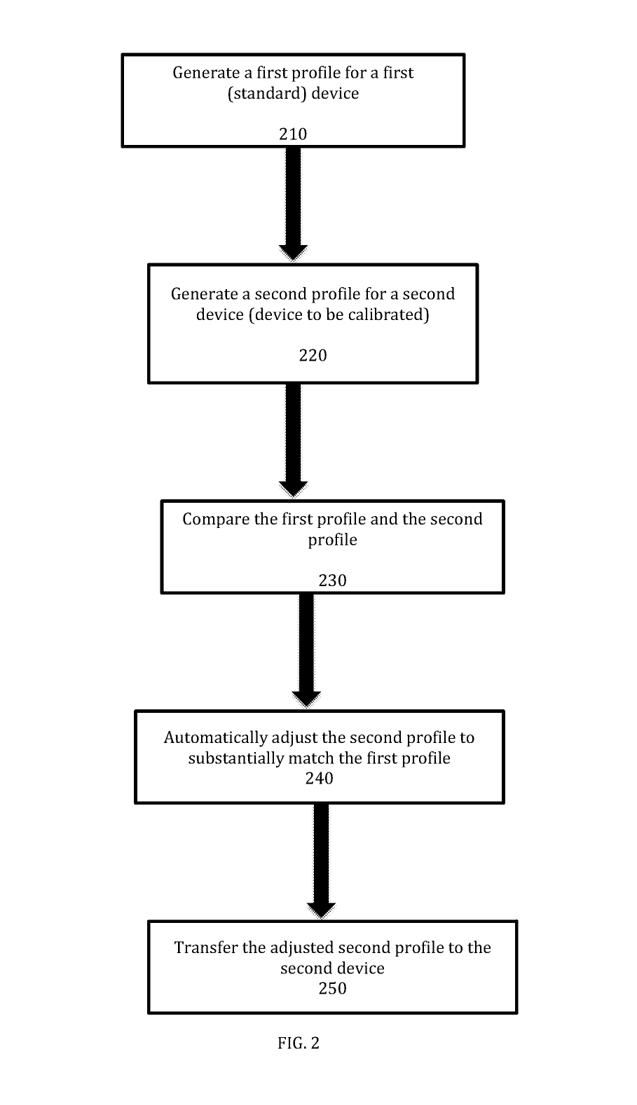

FIG. 2 is a flow chart of a computer-implemented method to calibrate a device according to another embodiment. As shown in step 210, a first profile may be generated for a first device. The first device may be a standard instrument. Accordingly, the first device may be a relatively highly accurate device. A second profile may be generated for a second device (step 220). The second device is a device that has to be calibrated or re-calibrated. The second device is relatively inaccurate in comparison to the first device. The first profile and the second profile are automatically compared as shown in step 230. If the first profile and the second profile do not match, adjustments can be made to the second profile such that it substantially matches the first profile (step 240). As shown in step 250, the adjusted second profile can be transferred to the second device to calibrate the second device. The process may be repeated as needed until the second device takes on the profile of the first device.

The calibrator 50 can include a computer readable medium 55. Computer program instructions may be stored in a computer readable medium 55 that can direct a computer, other programmable data processing apparatus, or other devices to function in a particular manner, such that the instructions stored in the computer readable medium 55 produce an article of manufacture including instructions which implement the function/act specified in the flowchart and/or block diagram block or blocks as shown in FIG. 2. The computer program instructions may also be loaded onto a computer, other programmable data processing apparatus, or other devices to cause a series of operational steps to be performed on the computer, other programmable apparatus or other devices to produce a computer implemented process.

As will be appreciated by one skilled in the art, aspects of the calibrator 50 may be embodied as a system (such as, a data processing system or a computer), method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “can,” “may” and similar terms are used to indicate that an item, condition or step being referred to is an optional (not required) feature of the invention. It should also be understood that, as used herein, “first,” “second,” “third,” etc., are arbitrarily assigned and are merely intended to differentiate between two or more devices, profiles, etc., as the case may be, and does not indicate any particular sequence. Furthermore, it is to be understood that the mere use of the term “first” does not require that there be any “second,” and the mere use of the term “second” does not require that there be any “third,” etc.

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer implemented method for calibrating a second device against a first device comprising:
comparing a profile of the second device against a profile of the first device;
automatically adjusting the profile of the second device such that it substantially matches the profile of the first device; and
transferring the adjusted profile to the second device,
wherein the transferring the adjusted profile to the second device causes the second device to provide substantially the same output as the first device in response to a same input parameter.

2. The method according to claim 1, wherein the first device is a substantially accurate standard device.

3. The method according to claim 1, further comprising:
generating a profile of the first device; and
generating a profile of the second device.

4. The method according to claim 1, further comprising creating one or more profiling scenarios.

5. The method according to claim 1, wherein the first device and the second device are configured to measure the input parameter.

6. The method according to claim 1, wherein the first and the second devices are pressure transducers

7. The method according to claim 1, wherein the first device and the second device are configured to measure fluid pressure.

8. A computer program product for calibrating a second device against a first device comprising:
one or more non-transitory storage mediums;
program instructions stored on the one or more non-transitory storage mediums, wherein the program instructions are able to be executed by one or more processors for:
comparing a profile of the second device against a profile of the first device;
automatically adjusting the profile of the second device such that it substantially matches the profile of the first device; and
transferring the adjusted profile to the second device,
wherein the transferring the adjusted profile to the second device causes the second device to provide substantially the same output as the first device in response to a same input parameter.

9. The computer program product according to claim 8, wherein the first device is a substantially accurate standard device.

10. The computer program product according to claim 8, further comprising program instructions for:
generating a profile of the first device; and
generating a profile of the second device.

11. The computer program product according to claim 8, further comprising program instructions for creating one or more profiling scenarios.

12. The computer program product according to claim 8, wherein the first device and the second device are configured to measure the input parameter.

13. The computer program product according to claim 8, wherein the first and the second devices are pressure transducers.

14. The computer program product according to claim 8, wherein the first device and the second device are configured to measure fluid pressure.

15. A system comprising:
one or more processors;
one or more non-transitory storage mediums;
program instructions stored on the one or more non-transitory storage mediums,
wherein the one or more processors execute the program instructions for:
comparing a profile of a second device against a profile of a first device;
automatically adjusting the profile of the second device such that it substantially matches the profile of the first device; and
transferring the adjusted profile to the second device,
wherein transferring the adjusted profile to the second device causes the second device to provide substantially the same output as the first device in response to a same input parameter.

16. The system according to claim 15, wherein the first device is a substantially accurate standard device.

17. The system according to claim 15, further comprising program instructions for:
generating a profile of the first device; and
generating a profile of the second device.

18. The system according to claim 15, further comprising program instructions for creating one or more profiling scenarios.

19. The system according to claim 15, wherein the first device and the second device are configured to measure the input parameter.

20. The system according to claim 15, wherein the first and the second devices are pressure transducers.
